(19) United States
(12) Patent Application Publication
(10) Pub. No.: US 2014/0156587 A1
(43) Pub. Date: Jun. 5, 2014

(54) RDF DATA WAREHOUSE VIA PARTITIONING AND REPLICATION

(71) Applicant: Ontotext AD, Sofia (BG)

(72) Inventors: Vassil Momtchev, Sofia (BG); Konstantin Pentchev, Sofia (BG); Deyan Peychev, Sofia (BG)

(73) Assignee: Ontotext AD, Sofia (BG)

(21) Appl. No.: 13/922,047

(22) Filed: Jun. 19, 2013

Related U.S. Application Data
(60) Provisional application No. 61/661,718, filed on Jun. 19, 2012.

(51) Int. Cl. G06F 17/30

(52) U.S. Cl. CPC G06F 17/30592
USPC 707/600

(57) ABSTRACT

Hardware and/or software suitable for RDF data warehousing, a type of data integration wherein integrated information is represented as RDF and loaded into a centralized RDF database, is presented. Pieces of hardware/software suitably support desired performance and flexibility by transforming one or more RDF documents to a binary format where RDF resources are replaced by identifiers, indexing each integrated data source into a separate RDF database and finally merging data to a warehouse through merging steps. The RDF data warehousing is a special type of data integration approach that allows query optimization.

### CROSS-REFERENCE TO RELATED APPLICATION

This application claims the benefit of Provisional Application No. 61/661718, filed Jun. 19, 2012, which is incorporated herein by reference.

### TECHNICAL HELD

The present subject matter generally relates to computing, and more particularly, relates to RDF data warehousing.

### BACKGROUND

An ontological database uses Resource Description Framework (RDF), Resource Description Framework Schema (RDFS), and Web Ontology Language (which has come to be known as OWL). RDF is a notion that any knowledge can be represented as a tuple or statement containing a subject, predicate, and object. While RDF does not impose any limits for the subjects, predicates, and objects, RDFS adds rules to constrain the values of the subjects, predicates, and objects to certain domains and ranges. After RDFS was introduced, it was felt there was a need for patterns of knowledge to be expressed as rules. OWL was developed to allow knowledge to be inferred from an existing set of RDF information using inference rules, which further restricts the values of subjects, predicates, and objects.

Since RDF expressions are usually embedded in a web document, there are compliance practices. For example, to ensure syntax correctness of the RDF statements, the following header is included: “xmlns:rdf=http://www.w3.org/1999/02/22-rdf-syntax ns#”. To control the meaning of the RDF statements, RDFS adds the following rules: rdfs:class/rdfs:subclass (which declares different classes and their sub-classes); rdf:type (which declares instances of classes [resources can be instances of zero, one or many classes and class membership can be inferred from behavior]); rdf:property/rdfs:subpropertyof (which declares different predicates [properties] and sub-properties [but properties are not tied to a class]); rdfs:range (which declares the rules of a property to restrict which classes of resources can be the object of the predicate); and rdfs:domain (which declares the rules of a property to restrict which classes of resources can be the subject of the predicate).

A data warehouse is a database used for data analysis by focusing on a specific form of data storage. There is a need to warehouse RDF data so that it can be transformed, cataloged, and made accessible for use by others for data mining, online analytical processing, market research, and decision support.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

One aspect of the subject matter includes a system form which recites a system of hardware for implementing an RDF warehouse, which comprises an RDF staging hardware whose structure is communicable with an RDF conversion hardware and whose structure has a capacity to convert a data source to an RDF document. The system further comprises an RDF integration hardware whose structure is communicable with an identifier conversion hardware and whose structure has a capacity to convert the RDF syntax of the RDF document into RDF binary data using an RDF binary representation and an RDF dictionary. The system yet further comprises an RDF warehouse database for storing merged RDF binary data.

Another aspect of the subject matter includes a method form which recites a method for warehousing merged RDF binary data, which comprises transforming an RDF document into RDF binary data using an RDF binary representation and sorting and indexing the RDF binary data in an RDF database. The method further comprises merging the RDF binary data in the RDF database into a first RDF warehouse database.

A further aspect of the subject matter includes a computer-readable medium form which recites a computer-readable medium, which is non-transitory, having stored thereon computer-executable instructions for implementing a method for warehousing merged RDF binary data. The method comprises transforming an RDF document into RDF binary data using an RDF binary representation and sorting and indexing the RDF binary data in an RDF database. The method farther comprises merging the RDF binary data in the RDF database into a first RDF warehouse database.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrating archetypical pieces of hardware for implementing an RDF data warehouse in accordance with one embodiment of the present subject matter;

FIG. 2 is a pictorial diagram illustrating archetypical data structures produced by pieces of hardware implementing an RDF data warehouse in accordance with one embodiment of the present subject matter;

FIGS. 3A-3I are process diagrams illustrating a method for warehousing RDF data in accordance with one embodiment of the present subject matter;

FIG. 4 is a pictorial diagram illustrating an exemplary RDF document;

FIG. 5 is a pictorial diagram illustrating exemplary portions of the RDF syntax of the RDF document;

FIG. 6 is a pictorial diagram illustrating an archetypical RDF dictionary of the RDF document;

FIG. 7 is a pictorial diagram illustrating an archetypical RDF binary representation of the RDF document;

FIGS. 8A-8B are pictorial diagrams illustrating archetypical binary formats of the RDF binary files;

FIG. 9 is a block diagram illustrating archetypical hardware suitable for forming RDF databases and its indices; and

FIG. 10 is a pictorial diagram illustrating an archetypical merging of two RDF database indices and a resultant merged index.

### DETAILED DESCRIPTION

Various embodiments of the present subject matter are directed to hardware and/or software suitable for RDF data warehousing, a type of data integration where integrated information is represented as RDF and loaded into a centralized RDF database. Various embodiments suitably support desired performance and flexibility by transforming one or more RDF documents to a binary format where RDF resources are replaced by identifiers, indexing each integrated data source into a separate RDF database, and finally merging data to a warehouse through merging steps. In some embodiments, a process implements RDF data warehousing, which is suitably efficient since data can be indexed in a distributed way in smaller chunks and flexible since it allows testing one or more RDF databases individually. Furthermore, RDF data warehousing is a special type of data integration approach in a few embodiments that allows the execution of very fast queries as well as control over the quality of the data and the query optimization. Various embodiments present a process for RDF data warehousing that boost the performance of the process and enable various features.

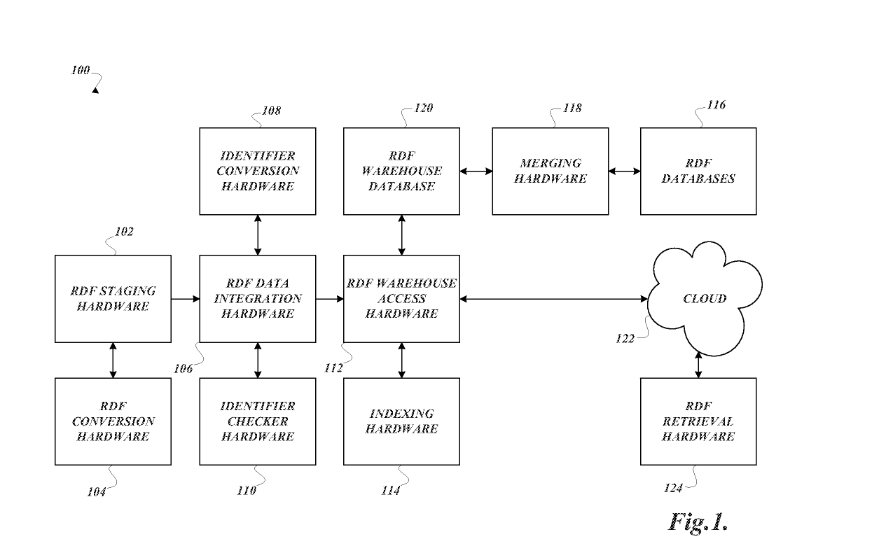

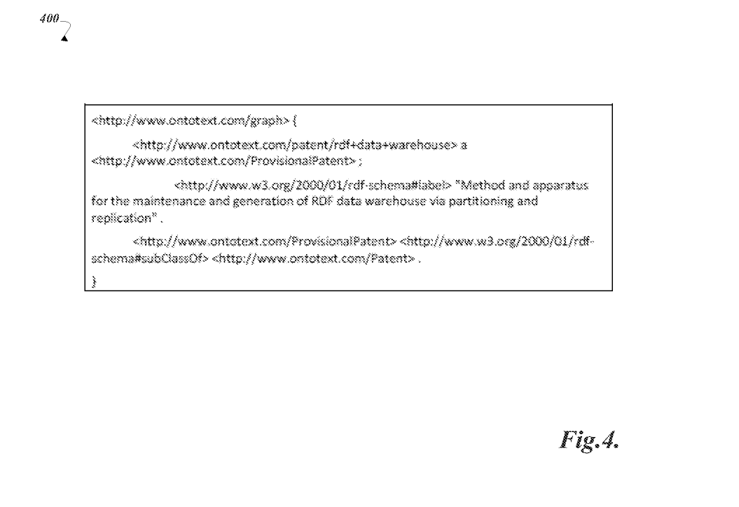

FIG. 1 illustrates a system 100 that includes an RDF staging hardware 102, which is a structure suitable for storing or accessing raw data extracted from each of several disparate data sources, The RDF staging hardware 102 communicates with an RDF conversion hardware 104, which structure has the capacity to convert a portion of or the whole of a data source (not shown) to an RDF document 400 using RDF syntax. See FIG. 4. The RDF document 400 is presented in a suitable semantic Web format, such as the TriG serialization format for RDF graphs. The RDF document 400 recites the name of a named graph and then is sequentially delimited by the pair of curly brackets “{ }.” The name of the named graph is recited as “<http://www.ontotext.com/graph>.” Contained within the named graph is a set of RDF statements. There are three statements in the RDF document 400. The first RDF statement is recited as follows: “http://www.ontotext.com/patent/rdf+data+warehouse a <http://www.ontotext.com/ProvisionalPatent>.” The second RDF statement recites: “http://www.w3.org/2000/01/rdf-schema#label ‘Method and apparatus for the maintenance and generation of RDF data warehouse via petitioning and replication.’” The third RDF statement recites: <http://www.ontotext.com/ProvisionalPatent>http://www.w3.org/2000/01/rdf-schema#subClassOf<http://www.ontotext.com/Patent>.”

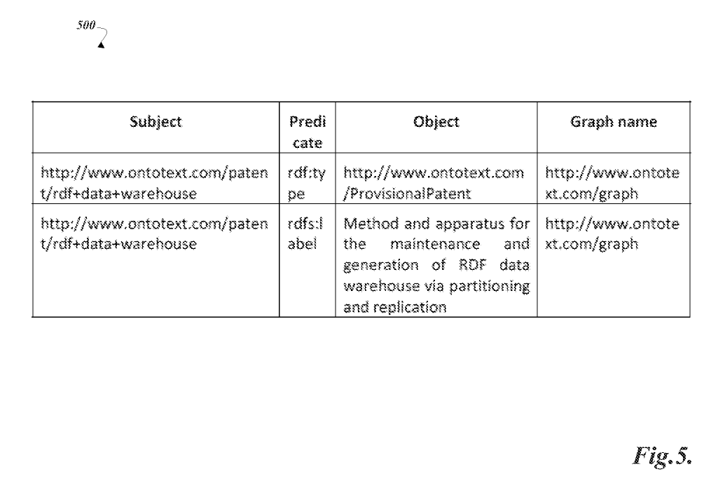

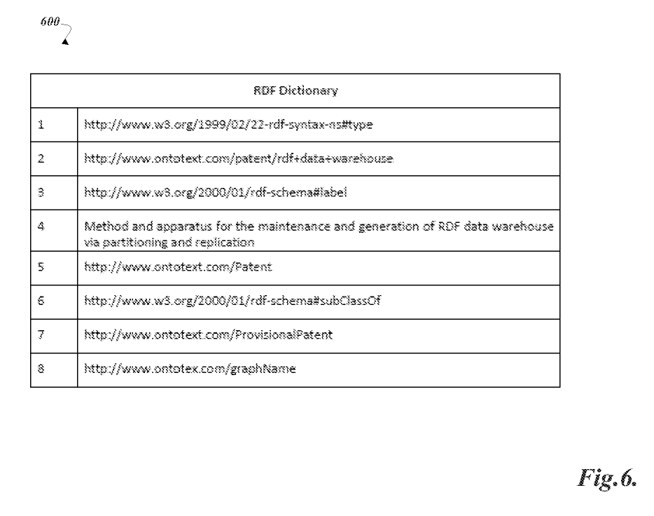

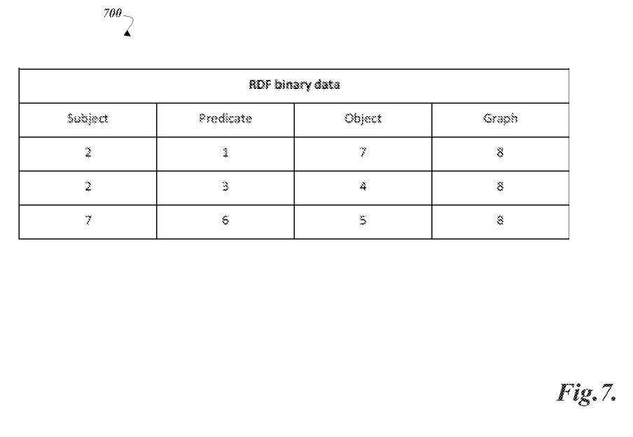

The RDF document 400 and other RDF documents are presented to an RDF data integration hardware 106. The RIDE data integration hardware 106 is a structure that is suitable for communicating with an identifier conversion hardware 108, which structure has the capacity to convert the RDF syntax of the RDF document 400 into an RDF binary representation, such as the RDF binary data representation 700 (FIG. 7) using an RDF dictionary, such as the RDF dictionary 600 (FIG. 6). A matrix 500 illustrates the RDF syntax of portions of the RDF document 400. See FIG. 5. Each RDF binary file contains two data structures, the RDF dictionary 600, which keeps track of all RDF values to internal identifiers (shared across all RDF files), and the RDF binary data representation 700, which models one or more statements (subject, predicate, object, named graph) as quadruplets of identifiers. The data in the RDF binary file is imported into an RDF database (one of various RDF databases 106). The RDF database indexing can be run in parallel independently since values are already stored in the RDF dictionary 600 and the structure remains static during indexing.

FIG. 5 illustrates a matrix 500, which is a conceptual model composed from textual quadruplets of subjects, predicates, objects, and graph names, each of which is extracted from the RDF document 400. Each column denotes a portion of the quadruplet. For example, Column 1 captures the subject portion of the quadruplet, Column 2 captures the predicate of the quadruplet, Column 3 captures the object of the quadruplet, and Column 4 captures the graph name of the quadruplet. Each of the rows captures an RDF statement of the RDF document 400. For example, the first row of the matrix 500 captures the first RDF statement of the RDF document 400. The subject of the first RDF statement recites “http://www.ontotext.com/patent/rdf+data_warehouse” and denotes the RDF resource. The predicate of the first RDF statement recites “rdf:type” and denotes traits or aspects of the subject and further expresses a relationship between the subject and the following object. The object of the first statement recites “http://www.ontotext.com/ProvisionalPatent.” And, finally, the graph name portion is recited as “http://www.ontotext.com/graph” for the first RDF statement. The subject of the second RDF statement, which can be found in the RDF document 400, is recited as follows: “http://www.ontotext.com/patent/rdf+data+warehouse.” The predicate of the second RDF statement is recited as follows: “rdfs:label.” The object is recited as follows: “Method and apparatus for the maintenance and generation of RDF data warehouse via partitioning and replication.” And, finally, the graph name of the second RDF statement is recited as follows: “http://www.ontotext.com/graph”

FIG. 6 illustrates the RDF dictionary 600 that comprises two columns of a matrix. The first column recites identifiers that are used to identify a portion of a quadruplet of an RDF statement, which is contained in the second column. For example, the first row contains an identifier “1”, which is connected to a portion of an RDF resource “http://www.w3.org/1999/02/22-rdf-syntax-ns#type.” The second row contains an identifier “2”, which is connected to a portion of an RDF resource “http://www.ontotext.com/patent/rdf+data+warehouse.” The third row contains an identifier “3”, which is connected to a portion of an RDF resource “http://www.w3.org/2000/01/rdf-schema#label.” The fourth row contains an identifier “4”, which is connected to a portion of an RDF resource “Method and apparatus for the maintenance and generation of RDF data warehouse via portioning and replication.” The fifth row contains an identifier “5”, which is connected to a portion of an RDF resource “http://www.ontotextcom/Patent.” The sixth row contains an identifier “6”, which is connected to a portion of an RDF resource “http://www.w3.org/2000/01/rdf-schema#subClassOf.” The seventh row contains an identifier “7”, which is connected to a portion of an RDF resource “http://www.ontotext.com/ProvisionalPatent.” The eighth row contains an identifier “8”, which is connected to a portion of an RDF resource “http://www.ontotext.com/graphName.”

FIG. 7 illustrates a matrix 700 that captures the RDF binary representation of the RDF document 400. The matrix 700 comprises four columns, each reciting a portion of an identifier quadruplet: “Subject,” “Predicate,” “Object,” and “Graph.” Each row contains a set of identifiers that together represent an RDF statement found in the RDF document 400. For example, the first row contains identifiers “2, 1, 7, and 8.” Using the RDF dictionary 600, each of the identifiers can be located, and the original textual RDF portion of the RDF statement can be found. Similarly, the second row recites RDF binary statement “2, 3, 4, and 8.” Again, using the RDF dictionary 600, the RDF binary statement could be resolved textually back to the original RDF statement found in the RDF document 400. The third row recites an RDF binary expression “7, 6, 5, and 8.” And, again, the RDF dictionary 600 can be used to resolve each of the binary representations to its original RDF portion of the RDF statement.

The RDF data integration hardware 106 also communicates with an identifier checker hardware 110, which structure is suitable for checking identifiers of the RDF dictionary 600 to preclude duplication of identifiers in the RDF dictionary 600. The RDF binary representation 700 of the RDF document 400 is presented by the RDF data integration hardware 106 to an RDF warehouse access hardware 112, which structure has a capacity to arrange RDF binary data contained in the RDF binary representation 700 into hierarchical groups according to dimensions or facts or aggregate facts, which collectively form a star schema. The RDF warehouse access hardware 112 uses indexing hardware 114, which structure is suitable for indexing various RDF databases 116. A merging hardware 118 is a structure having a capacity to merge RDF binary data in the RDF databases 116 to an RDF warehouse database 120. RDF retrieval hardware 124 is a structure suitable for accessing the merged RDF binary data in the RDF warehouse database 120 via a cloud 122 through the RDF warehouse access hardware 112.

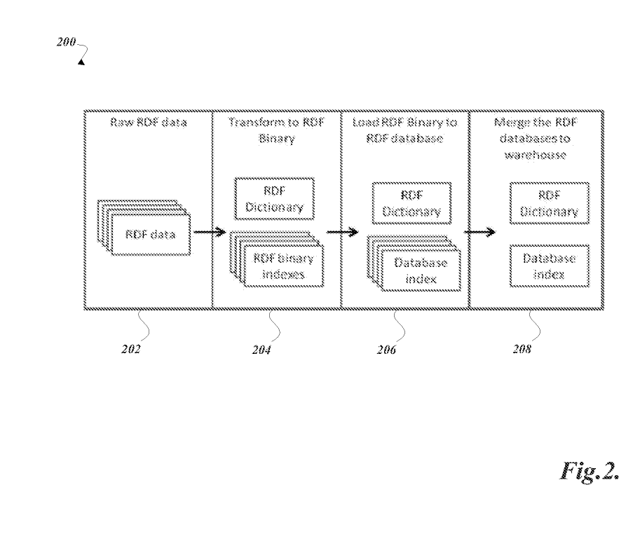

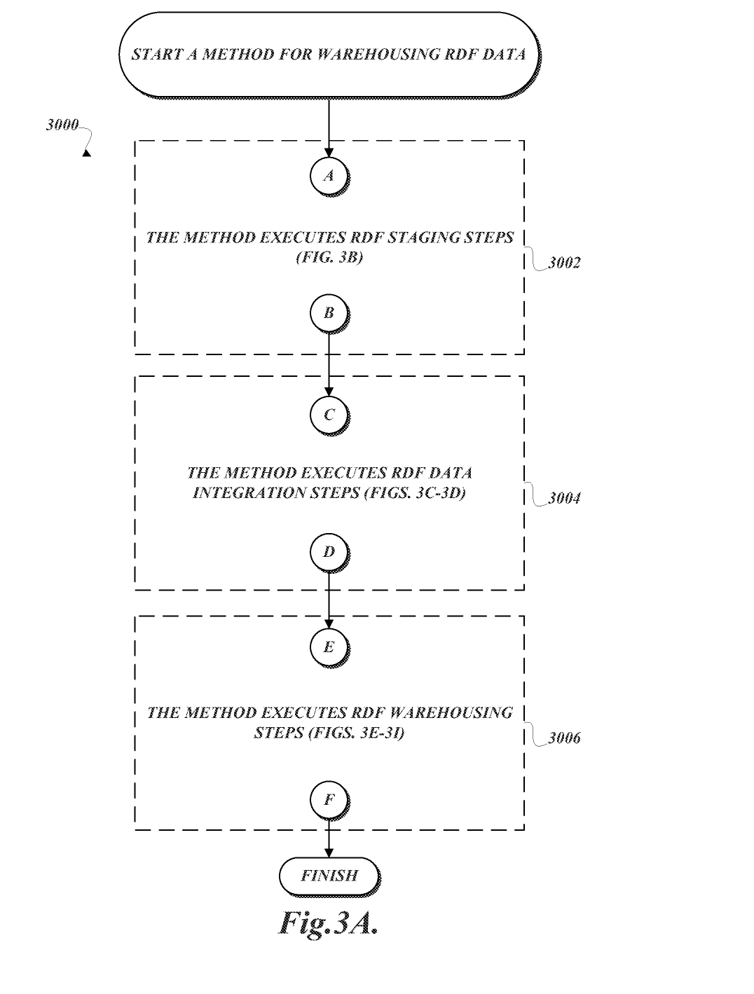

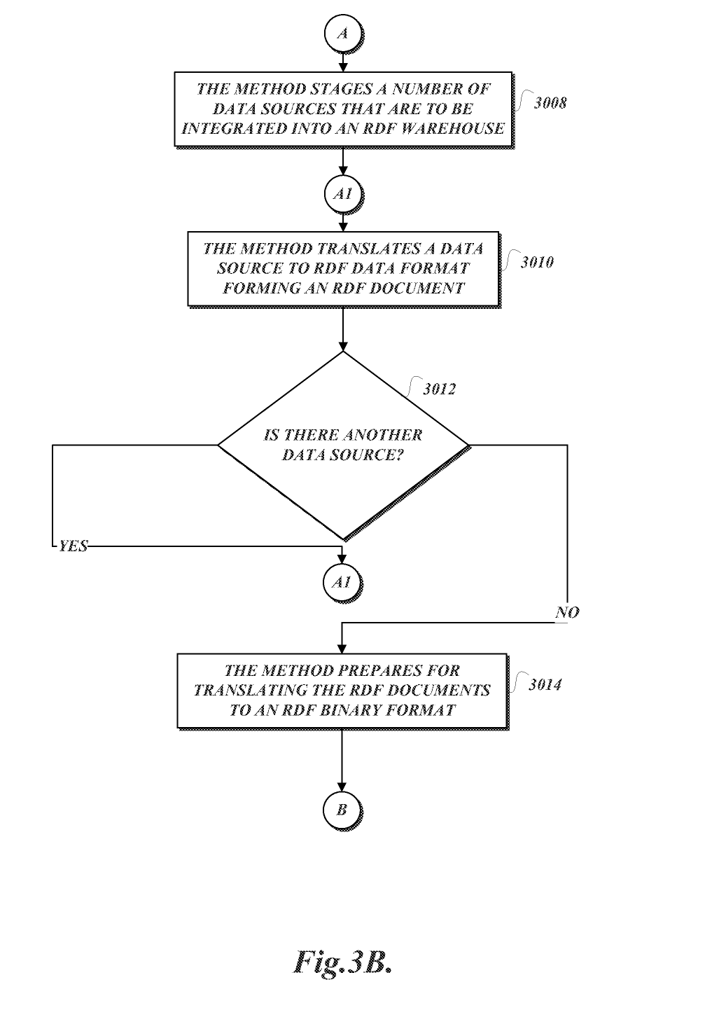

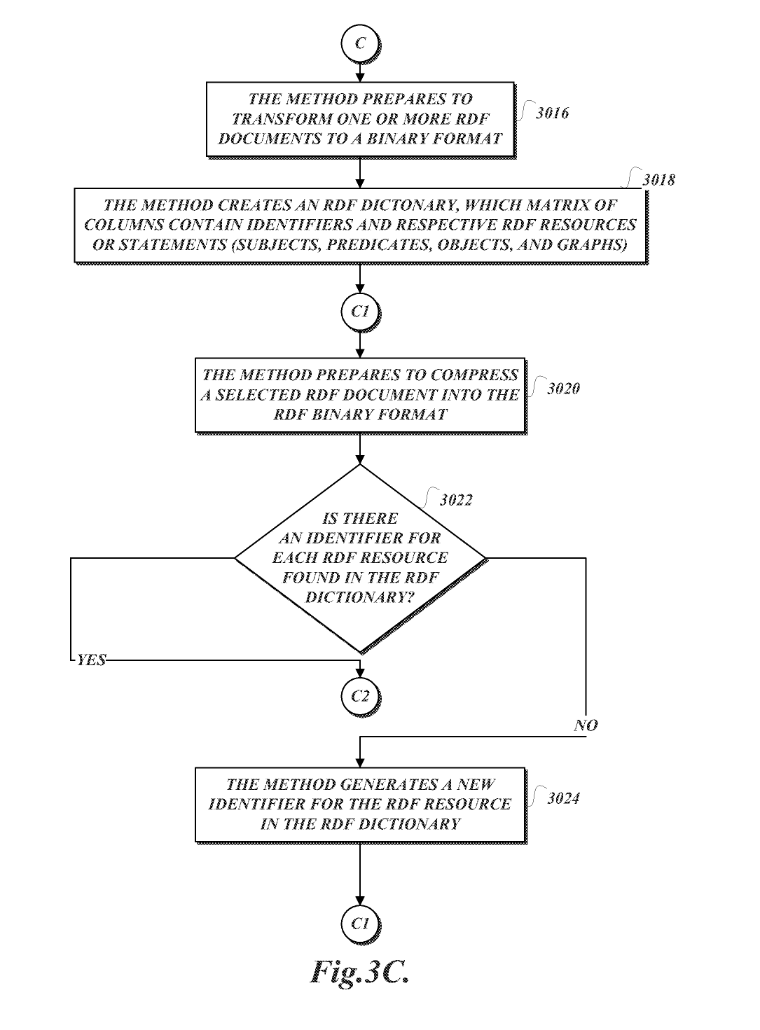

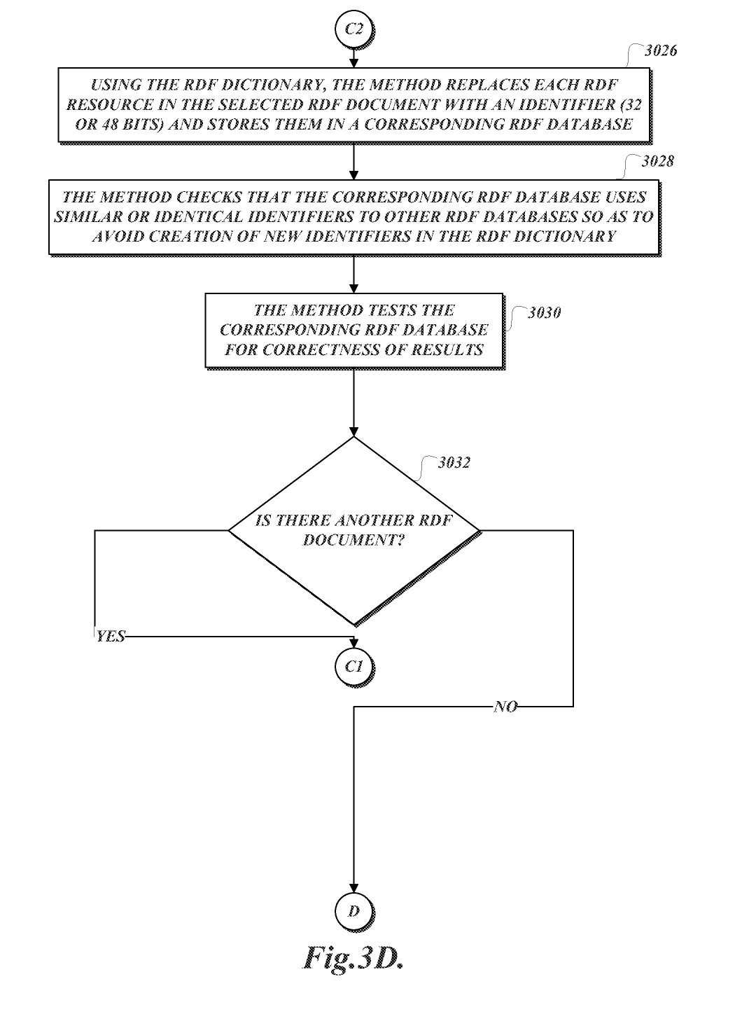

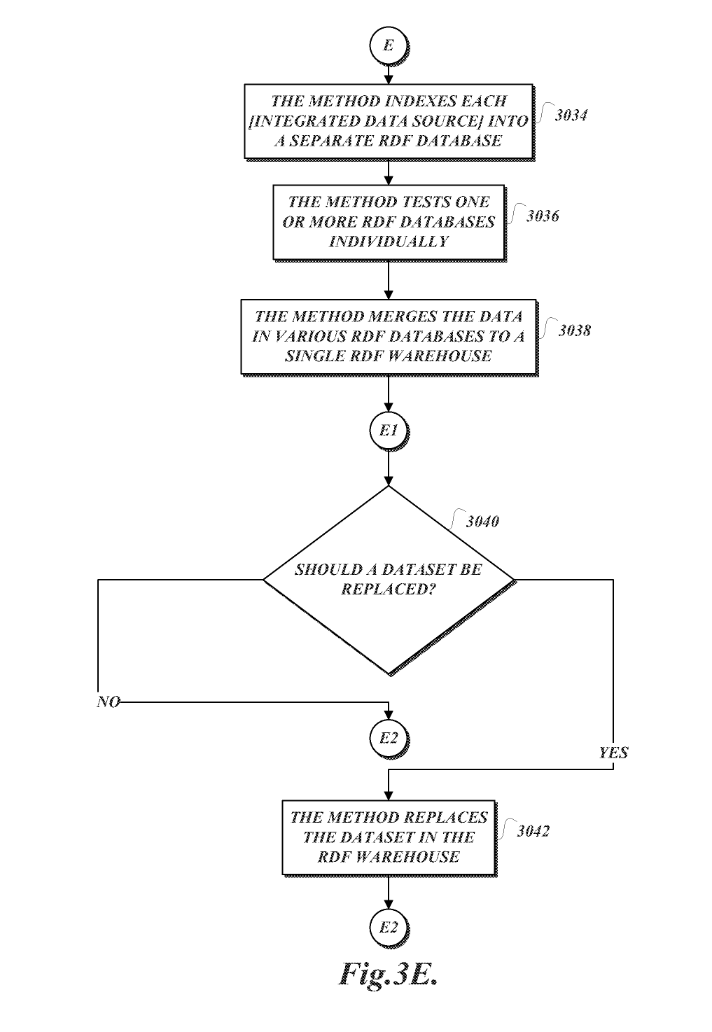

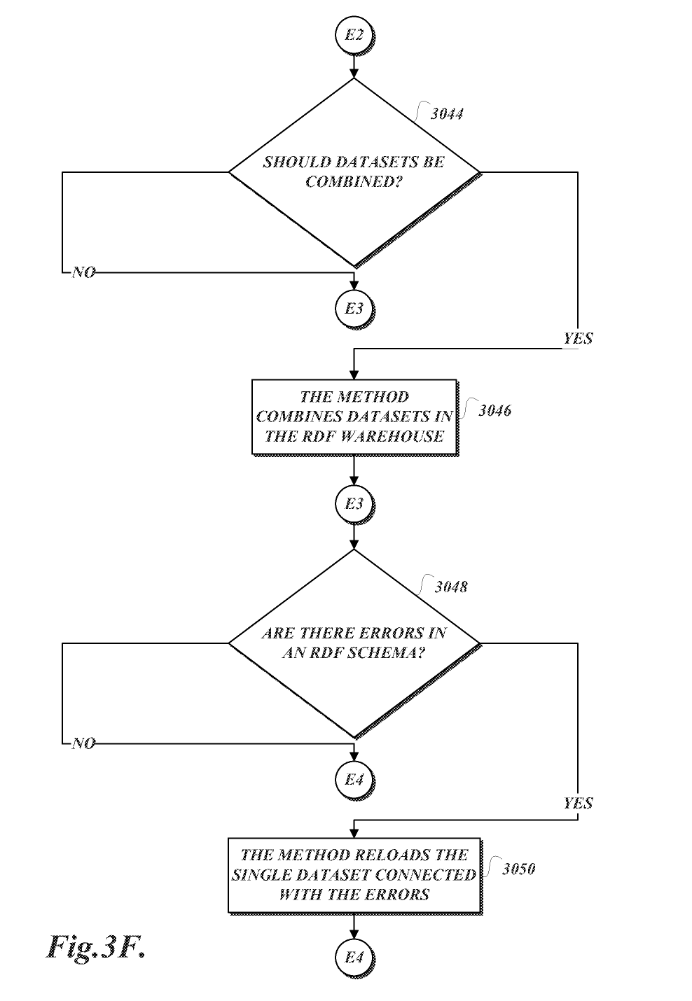

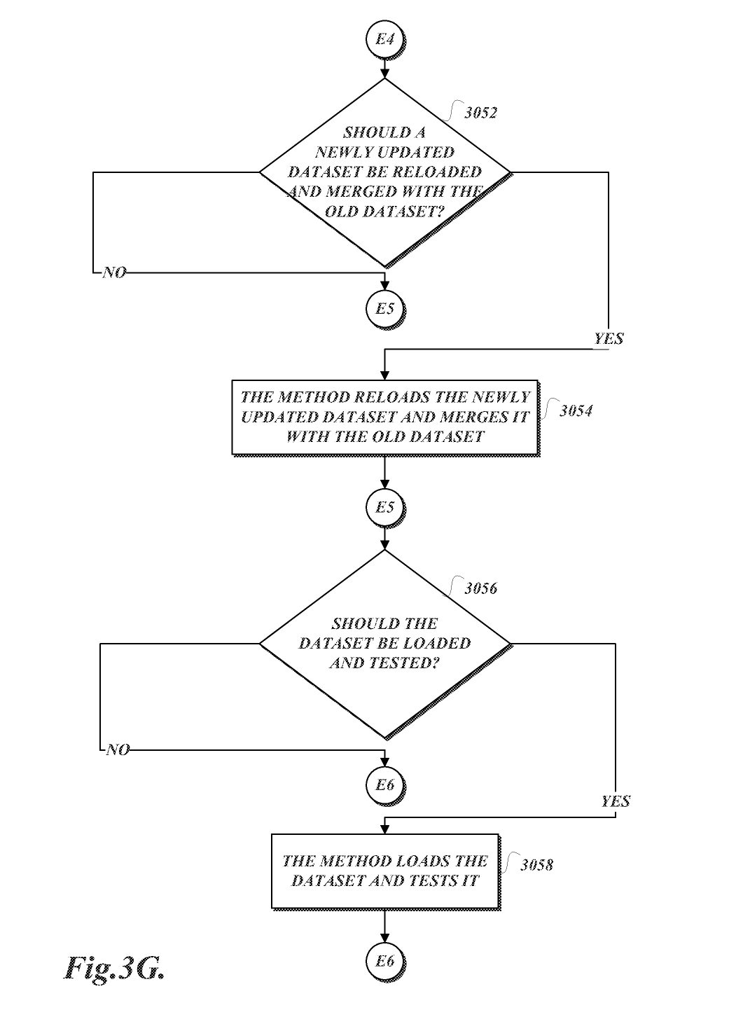

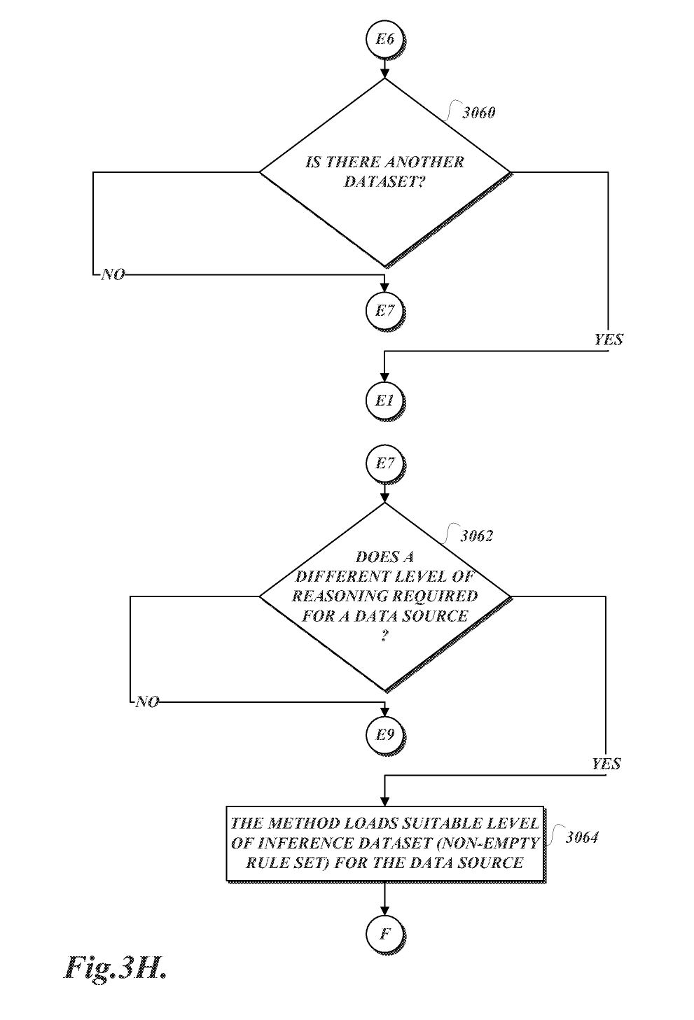

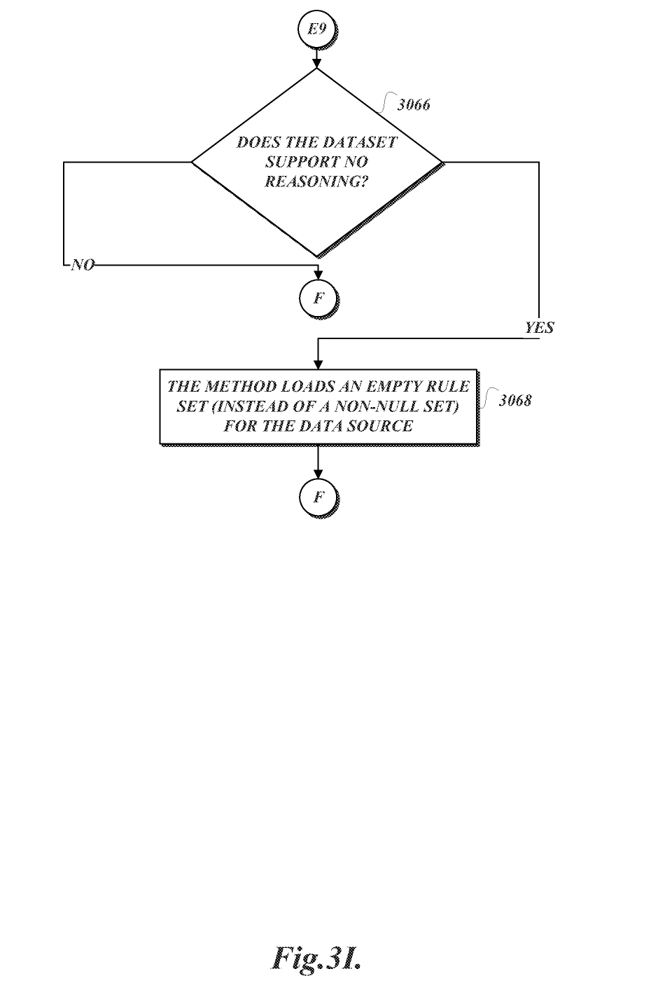

FIG. 2 illustrates data structures that are produced by various stages 202-208 by pieces of hardware of the system 100 or by the steps of the method of FIGS. 3A-3I. The stage 202 is where the RDF conversion hardware 104 converts a data source into the RDF document 400 containing RDF data. The stage 204 is where the RDF data integration hardware 106 and its associated pieces of hardware transform the RDF document 400 into the RDF binary representation 700 through the use of the RDF dictionary 600. Various RDF binary indices are optionally produced at the stage 204. The stage 206 is implemented by the RDF warehouse access hardware 112 and its associated pieces of hardware for loading RDF binary representation to the various RDF databases 116. The stage 206 uses the RDF dictionary 600 that may be revised to include new identifiers that have been detected. Other data structures are optionally produced including various database indices. The final stage, stage 208, is implemented by the merging hardware 118 to merge the various RDF databases 116 to the RDF warehouse database 120. Again, the RDF dictionary 600 is used in this stage as well as the production of a merged database index.

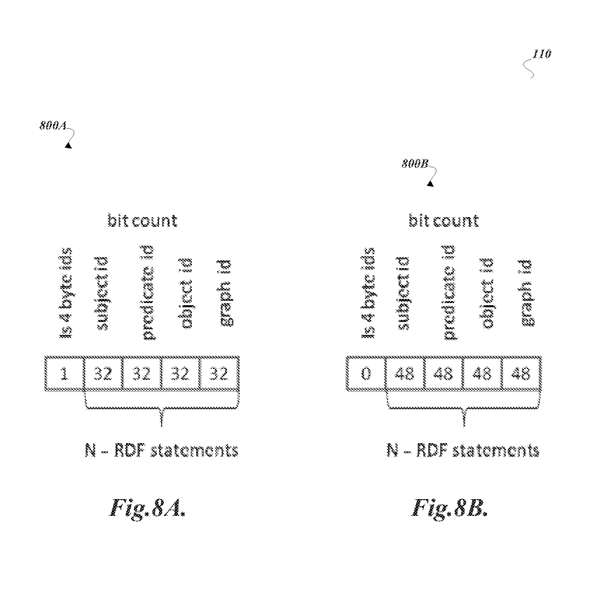

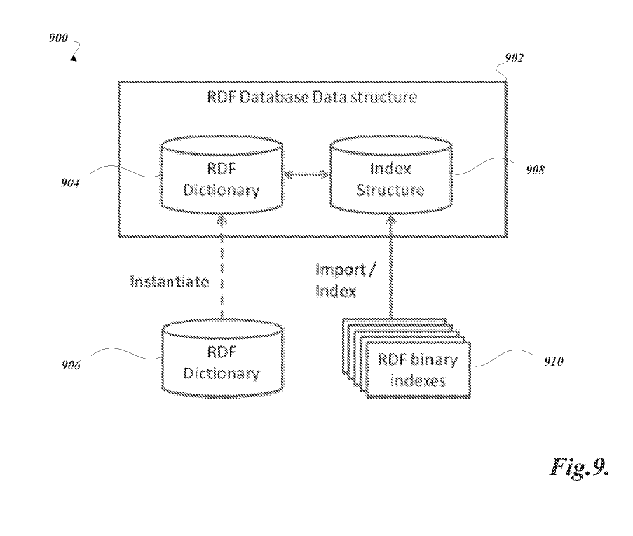

FIGS. 8A-8B are archetypical RDF binary formats for encoding RDF binary representations. FIG. 8A illustrates an RDF binary format 800a that encrypts a binary quadruplet of an RDF statement. The initial portion of the bit count of the RDF format 800a denotes an identifier for the RDF statement. In one embodiment, the identifier occupies the least significant four bytes of the bit count. The next 32 bits encapsulate the subject of the quadruplet. The next 32 bits encapsulate the predicate. The next 32 bits encapsulate the object And the final 32 bits encapsulate the graph name. FIG. 8B illustrates an RDF binary format 800b that expresses an encoding of a binary quadruplet of an RDF statement. The first portion of the bit count of the RDF format 800b, indicates an identifier that occupies the least significant four bytes of the bit count. The next 48 bits indicate the subject. The next 48 bits indicate the predicate. The next 48 bits indicates the object. And the final 48 bits indicate the graph name of the RDF statement.

Each RDF binary format is a mechanism to compress RDF data and to reduce the complexity of performing computational manipulation of knowledge such as comparing whether two RDF files are one and the same. Another example comprises of computational instructions to merge all statements from N-number of files. The system 100 receives as input data different formats including RDFAML, N-Triples, N3, Turtle, TriG or TriX, and so on. In turn, the system 100 outputs a named graph and outputs two structures. The first structure is the RDF dictionary 600, which is a data structure that uniquely identifies all already seen RDF values with internal identifiers. The RDF dictionary 600 is capable of very fast and efficient lookup operations, such as providing the identifiers for a given value, or if the value is seen for the first time, associating it with the next free identifier, and so on. The second structure is the RDF binary data representation 700 which is a data structure that stores all RDF statements as a list of quadruplets of internal identifiers. Each representation of the RDF document 400, be it textual or binary, could be transformed from one to the other without loss of information. The RDF binary data format supports two formats depending on identifier size. The RDF dictionary 600 may use 32-bit or 48-bit identifiers, which allows for 2³²-1 or 2⁴⁸-1 maximum storage size. The first bit of the data format indicates whether 32- or 48-bit identifiers are used, and the rest comprises of a series of identifiers that denote the subject, predicate, object, and graph name.

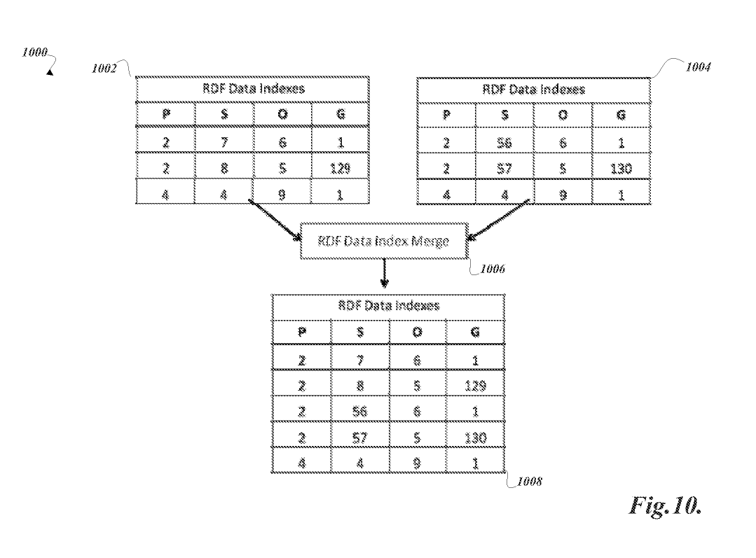

FIG. 9 illustrates the building of RDF database indices by the indexing hardware 114. Using an RDF dictionary 906 and various RDF binary indices 910, an RDF database data structure 902 is instantiated containing an RDF dictionary 904 as well as a merged index stricture 908. The indexing hardware 114 indexes the RDF binary files with a database engine. An RUE database engine creates multiple sorted collections that represent the RDF data, where for efficiency reasons, internal identifiers are used. Each index has different soiling, which allows suitably fast lookup access. The sorting algorithm could be denoted as an abbreviation for the first letters of sorted columns. For example, PSOG means sorted by predicate, subject, object, and graph in ascending order. POSG stands for sorted by predicate, object, subject, and graph in ascending order.

FIG. 10 illustrates the merging of two RDF data indexes 1002, 1004 into a merged data index 1008. This merging allows merging an arbitrary number of RDF database indices into a single one without reindexing (resorting) all information. This occurs during the creation of the RDF warehouse database 120 that aggregates all information from an arbitrary collection of RDF databases 116 that were initialized with the same RDF dictionary 600. Since all indexes of the RDF databases 116 are using one and the same RDF dictionary 600 (i.e. the URI http://www.w3.org/2000/01/rdf-schema#subClassOf is mapped to the same identifier in all databases), it is enough to list all information from the RDF databases 116 and write it to the resulting combined index 1008 by preserving the index sort order and deduplicating the redundant RDF statements. The combined index 1008 is in the form of graph identifiers (PSOG). The algorithm complexity is linear and requires a limited amount of memory to keep the first record of each sorted RDF database index in a sorted queue. The merging algorithm then composes into: (1) starting parallel thread for each index type, i.e. PSOG, POSG, PGSO and so on; (2) taking the first (smallest) RDF record from each merged RDF database index and putting it into a sorted queue, which implements the same sorting algorithm as the type of index; (3) writing the smallest element to the output index if it is different from the last one inserted and put the next element from the database index it originates from into the sorted algorithm; and (4) repeating step 3 until all index elements are iterated and the algorithm finishes.

The merged RDF data index 1008 is made possible by a piece of hardware 1006 for performing the RDF data index merge. The RDF data indexes 1002 is a matrix of four columns and three rows. The first column denotes the predicate, the second column denotes the subject, the third column denotes the object, and the last column denotes the graph name. The first row expresses a binary statement “2, 7, 6, 1,” The second row expresses the binary statement “2, 8, 5, 129.” And the third row expresses the binary statement “4, 4, 9, and 1.” The RDF data indexes 1001 is a matrix of four columns and three rows. The first column denotes the predicate, the second column denotes the subject, the third column denotes the object, and the last column denotes the graph name. The first row expresses the RDF binary statement “2, 56, 6, and 1.” The second row expresses the RDF binary statement “2, 57, 5, and 130.” And the last row expresses the RDF binary statement “4, 4, 9, and 1.” When these two RDF data indexes 1002, 1004 are merged by the RDE data index merge hardware 1006, the RDF data indexes 1008 is produced. The RDF data indexes 1008 is a matrix of four columns and five rows. The first column denotes the predicate, the second column denotes the subject, the third column denotes the object, and the last column denotes the graph name. The first row expresses the RDF binary statement “2, 7, 6, and 1.” The second row expresses the RDF binary statement “2, 8, 5, and 129.” The third row expresses the RDF binary statement “2, 56, 6, and 1.” The fourth row expresses the RDE binary statement “2, 57, 5, and 130.” And the last row of the RDF data indexes 1008 expresses the RDF binary statement “4, 4, 9, and 1.”

FIGS. 3A-3I are process diagrams implementing a method 3000 for warehousing RDF data. From a start block, the method 3000 proceeds to a set of method steps 3002 defined between a continuation terminal (“Terminal A”) and another continuation terminal (“Terminal B”). The set of method steps 3002 executes RDF staging steps. From Terminal A (FIG. 3B), the method 3000 proceeds to block 3008 where the method stages a number of data sources that have to be integrated into an RDF warehouse. The method continues to another continuation terminal (“Terminal A1'). The method then proceeds to block 3010 where the method translates a data source to RDF syntax, forming an RDF document. At decision block 3012, a test is performed to determine whether there is another data source. If the answer to the test at decision block 3012 is YES, the method proceeds to Terminal A1 and skips back to block 3010 where the above-identified processing steps are repeated. Otherwise, the answer to the test at decision block 3012 is NO, and the method proceeds to block 3014 where the method prepares for translating the RDF documents into an RDF binary format. The method then continues to Terminal B.

From Terminal B (FIG. 3A), the method 3000 proceeds to a set of method steps 3004 defined between another continuation terminal (“Terminal C”) and another continuation terminal (“Terminal D”). The set of method steps 3004 executes RDF data integration steps. From Terminal C (FIG. 3C), the method proceeds to block 3016 where the method prepares to transform one or more RDF documents to a binary format. At block 3018, the method. creates an RDF dictionary, whose matrix of columns contains identifiers and respective RDF resources or statements (subjects, predicates, objects, and graphs). The method then continues to another continuation terminal (“Terminal C1”) and further proceeds to block 3020 where the method prepares to compress a selected RDF document into the RDF binary format. At decision block 3022, a test is performed to determine whether there is an identifier for each RDF resource found in the RDF dictionary. If the answer to the test at decision block 3022 is YES, the method proceeds to another continuation terminal (Terminal C2). Otherwise, if the answer to the test at decision block 3022 is NO, the method proceeds to block 3021 where the method generates a new identifier for the RDF resource in the RDF dictionary. The method then continues to Terminal C1 and skips back to block 3020 where the above-identified processing steps are repeated.

From Terminal C2 (FIG. 3D), the method proceeds to block 3026 where using the RDF dictionary, the method replaces each RDF resource in the selected RDF document with an identifier (32 or 48 bits) and stores them in a corresponding RDF database. At block 3028, the method checks that the corresponding RDF database uses similar or identical identifiers to other RDF databases so as to avoid creation of new identifiers in the RDF dictionary. At block 3030, the method tests the corresponding RDF database for correctness of results. The method then proceeds to decision block 3032 where a test is performed to determine whether there is another RDF document. If the answer to the test at decision block 3032 is YES, the method proceeds to Terminal C1 and skips back to block 3020 where the above-identified processing steps are repeated. Otherwise, the answer to the test at decision block 3032 is NO, and the method proceeds to Terminal D.

From Terminal D, the method proceeds to a set of method steps 3006 defined between a continuation terminal (“Terminal E”) and another continuation terminal (“Terminal F”). The set of method steps 3006 executes RDF warehousing steps. From Terminal E (FIG. 3E), the method proceeds to block 3034 where the method indexes each integrated data source into a separate RDF database. At block 3036, the method tests one or more RDF databases individually. At block 3038, the method merges the data in various RDF databases to a single RDF warehouse. The method then continues to another continuation terminal (“Terminal E1”). The method then further proceeds to a test at decision block 3040 where it is performed to determine whether a dataset should be replaced. If the answer to the test at decision block 3040 is NO, the method continues to another continuation terminal (“Terminal E2”). Otherwise, the answer to the test at decision block 3040 is YES, and the method proceeds to block 3042 where the method replaces the dataset in the RDF warehouse. The method then continues to Terminal E2.

From Terminal E2 (FIG. 3F), the method proceeds to decision block 3044 where a test is performed to determine whether the datasets should be combined. If the answer to the test at decision block 3044 is NO, the method proceeds to another continuation terminal (“Terminal E3”). Otherwise, the answer to the test at decision block 3044 is YES, and the method proceeds to block 3046 where the method combines datasets in the RDF warehouse. The method then continues to Terminal E3 and further proceeds to decision block 3048 where a test is performed to determine whether there are errors in the RDF schema. If the answer to the test at decision block 3048 is NO, the method proceeds to another continuation terminal (“Terminal E4”). Otherwise, if the answer to the test at decision block 3048 is YES, the method proceeds to block 3050 where the method reloads the single dataset connected with the errors. The method then continues to Terminal E4.

From Terminal E4 (FIG. 3G), the method proceeds to decision block 3052 where a test is performed to determine whether a newly updated dataset can be reloaded and merged with the old dataset. If the answer to the test at decision block 3052 is NO, the method proceeds to another continuation terminal (“Terminal E5”). Otherwise, if the answer to the test at decision block 3052 is YES, the method proceeds to block 3054 where the method reloads the newly updated dataset and merges it with the old dataset. The method then continues to Terminal E5 and further proceeds to decision block 3056 where a test is performed to determine whether the dataset should be reloaded and tested. If the answer to the test at decision block 3056 is NO, the method continues to another continuation terminal (“Terminal E6”). Otherwise, the answer to the test at decision block 3056 is YES, and the method proceeds to block 3058 where the method loads the dataset and tests it, The method then continues to Terminal E6. Digressing, this feature of reloading and testing each dataset one at a time allows faster computation operation rather than deleting a full data set and loading it with the full repository.

Returning, from Terminal E6 (FIG. 3H), the method proceeds to decision block 3060 where a test is performed to determine whether there is another dataset. If the answer to the test at decision block 3060 is NO, the method proceeds to another continuation terminal (“Terminal E7”). Otherwise, if the answer to the test at decision block 3060 is YES, the method continues to Terminal E1 and skips back to decision block 3040 where the above-identified processing steps are repeated. From Terminal E7 (FIG. 3H), the method proceeds to decision block 3062 where a test is performed to determine whether a different level of reasoning is required for a data source. If the answer to the test at decision block 3062 is NO, the method continues to another continuation terminal (“Terminal E9”). Otherwise, the answer to the test at decision block 3062 is YES, and the method proceeds to block 3064 where the method loads a suitable level of the inference dataset (non-empty rule set) for the data source. The method then continues to another continuation terminal (“Terminal F”). Digressing, each dataset may have different inference level from none to OWL2RL. The method allows no inference to be used if it is not needed.

Returning, from Terminal E9 (FIG. 3I), the method proceeds to decision block 3066 where a test is performed to determine whether the dataset supports no reasoning. If the answer to the test at decision block 3066 is NO, the method proceeds to Terminal F and terminates execution. Otherwise, the if the answer to the test at decision block 3066 is YES, the method proceeds to block 3068 where the method loads an empty rule set (instead of a non-null set) for the data source. The method then continues to Terminal F and terminates execution. Digressing, the above features include another feature that prevents, in some embodiments, arbitrary merges across the different datasets. It is possible that datasets modify other schemata or create long transitive chains. One benefit is that isolation of every dataset allows an inference of links in the scope of its graph. A further feature includes loading of a dataset in its own repository. The feature can load very big datasets for a short time. A benefit is that the complete dataset is loaded fully in the memory, which is faster and more manageable. The above features operate where the datasets may have different update frequencies and are operational for multiple RDF warehouses that share common datasets.

While illustrative embodiments have been illustrated and described, it will be appreciated that various changes can be made therein without departing from the spirit and scope of the invention.

The embodiments of the invention in which an exclusive property or privilege is claimed are defined as follows:

1. A system of hardware for implementing an RDF warehouse, comprising:
an RDF staging hardware which structure is communicable with an RDF conversion hardware and which structure has a capacity to convert a data source to an RDF document;
an RDF integration hardware which structure is communicable with an identifier conversion hardware and which structure has a capacity to convert RDF syntax of the RDF document into RDF binary data using an RDF binary representation and an RDF dictionary; and
an RDF warehouse database for storing merged RDF binary data.

2. The system of claim 1, further comprising an identifier checker hardware which structure is suitable for checking identifiers of the RDF dictionary to preclude duplication of identifiers in the RDF dictionary.

3. The system of claim 1, further comprising an RDF warehouse access hardware which structure has a capacity to allow access to the RDF warehouse database.

4. The system of claim 3, further comprising RDF databases suitable for storing RDF binary data.

5. The system of claim 4, further comprising an indexing hardware which structure is suitable for indexing the RDF databases.

6. The system of claim 4, further comprising a merging hardware which structure has a capacity to merge RDF binary data in the RDF databases to form the merged RDF binary data which is stored in the RDF warehouse database.

7. The system of claim 3, further comprising an RDF retrieval hardware which structure is suitable for accessing the merged RDF binary data in the RDF warehouse database via a cloud through the RDF warehouse access hardware.

8. A method for warehousing merged RDF binary data, comprising:
transforming an RDF document into RDF binary data using an RDF binary representation and sorting and. indexing the RDF binary data in an RDF database; and
merging the RDF binary data in the RDF database into a first RDF warehouse database.

9. The method of claim 8, wherein transforming includes creating an RDF dictionary which contains identifiers and corresponding RDF resources in the RDF document.

10. The method of claim 8, further checking that the RDF database uses similar identifiers to other RDF databases so as to avoid creation of new identifiers in the RDF dictionary.

11. The method of claim 8, further comprising replacing a dataset in a second RDF warehouse database, which shares the dataset with the first RDF warehouse database.

12. The method of claim 8, further comprising combining datasets in a second RDF warehouse database, which shares the datasets with the first RDF warehouse database.

13. The method of claim 8, farther comprising support different levels of reasoning for different datasets, which are shared by the first and a second RDF warehouse databases.

14. The method of claim 8, further comprising preventing merges across different datasets which is suitable to control reasoning to a dataset, which is shared by the first and a second RDF warehouse databases.

15. The method of claim 8, further comprising loading a dataset into its repository, which is shared by the first and a second RDF warehouse databases.

16. A computer-readable medium, which is non-transitory, having stored thereon computer-executable instructions for implementing a method for warehousing merged RDF binary data, comprising:
transforming an RDF document into RDF binary data using an RDF binary representation and sorting and indexing the RDF binary data in an RDF database; and
merging the RDF binary data in the RDF database into a first RDF warehouse database.

17. The computer-readable medium of claim 16, wherein transforming includes creating an RDF dictionary which contains identifiers and corresponding RDF resources in the RDF document.

18. The computer-readable medium of claim 16, further comprising replacing a dataset in a second RDF warehouse database, which shares the dataset with the first RDF warehouse database.

19. The computer-readable medium of claim 16, further comprising combining datasets in a second RDF warehouse database, which shares the datasets with the first RDF warehouse database.

20. The computer-readable medium of claim 16, further comprising support for different levels of reasoning for different datasets, which are shared by the first and a second RDF warehouse databases.
